(19) United States
(12) Patent Application Publication
(10) Pub. No.: US 2026/0254119 A1
(43) Pub. Date: Aug. 27, 2026

(54) ANTENNA DEVICE

(71) Applicant: WNC Corporation, Hsinchu (TW)

(72) Inventors: Wan Ju HUANG, Hsinchu (TW); Wen-Tsan CHUNG, Hsinchu (TW)

(21) Appl. No.: 19/547,764

(22) Filed: Feb. 24, 2026

(30) Foreign Application Priority Data
Feb. 26, 2025 (TW) 114107152

(51) Int. Cl. H01Q 9/04; H01Q 5/20

(52) U.S. Cl. CPC H01Q 9/0414; H01Q 5/20

(57) ABSTRACT

An antenna device is proposed. The antenna device includes a substrate, a ground layer, two connectors, a metal structure and two antenna units. The ground layer is disposed on the substrate. The two connectors are electrically connected to the ground layer. The metal structure is connected to the ground layer, and two ends of the metal structure are connected to the two connectors, respectively, via the ground layer. The two antenna units are connected to the two connectors, respectively.

### RELATED APPLICATIONS

This application claims the benefit of priority to Taiwan Patent Application No. 114107152, filed on February 26, 2025. The entire content of the above identified application is incorporated herein by reference.

### BACKGROUND

### Technical Field

The present disclosure relates to an antenna device.

### Description of the Related Art

When an electronic product includes at least two external antennas, and the external antennas are directly fastened to connectors on the circuit board or directly fastened to the housing of the communication product, a certain distance must be maintained between adjacent external antennas to avoid mutual interference and to prevent affecting the performance and characteristics of each other.

However, as the appearance of modern electronic products gradually becomes smaller, excessively small antenna spacing may cause the electronic product to fail to meet increasingly stringent Over The Air (OTA) testing standards. In view of this, how to develop an antenna device that can effectively utilize product space while maintaining antenna characteristics has become a goal worthy of research and development for related industries.

### SUMMARY

One aspect of the present disclosure is to provide an antenna device, which includes a substrate, a ground layer, two connectors, a metal structure, and two antenna units. The ground layer is disposed on the substrate. The two connectors are electrically connected to the ground layer. The metal structure is connected to the ground layer, and two ends of the metal structure are electrically connected to the two connectors, respectively, via the ground layer. The two antenna units are connected to the two connectors, respectively.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram illustrating an antenna device according to a first embodiment of the present disclosure.

FIG. 2 is a side view schematic diagram of the antenna device of FIG. 1.

FIG. 3 is a schematic diagram illustrating an antenna device according to a second embodiment of the present disclosure.

FIG. 4 is a top view schematic diagram of the antenna device of FIG. 3.

FIG. 5 is a side view schematic diagram of the antenna device of FIG. 3.

FIG. 6 is a schematic diagram illustrating efficiency of the antenna device of FIG. 3.

FIG. 7 is a schematic diagram illustrating an antenna device according to a third embodiment of the present disclosure.

### DETAILED DESCRIPTION

The present disclosure is more particularly described in the following embodiments that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

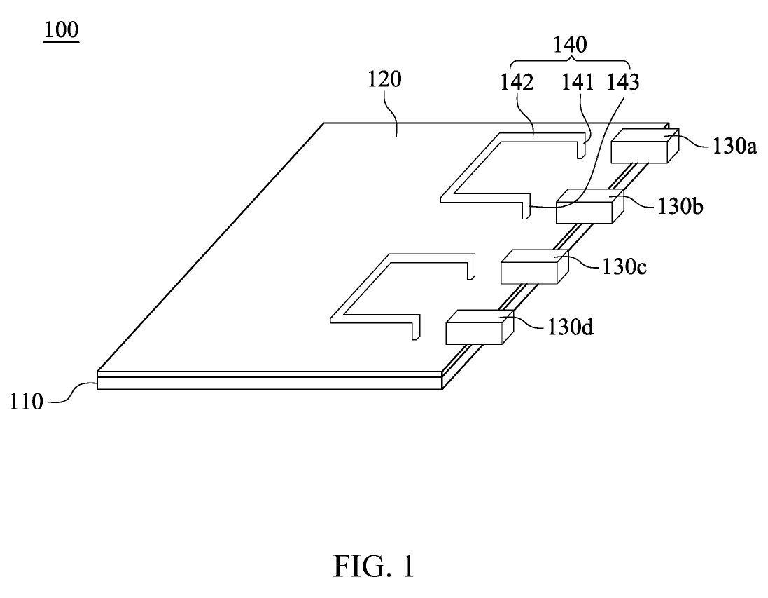

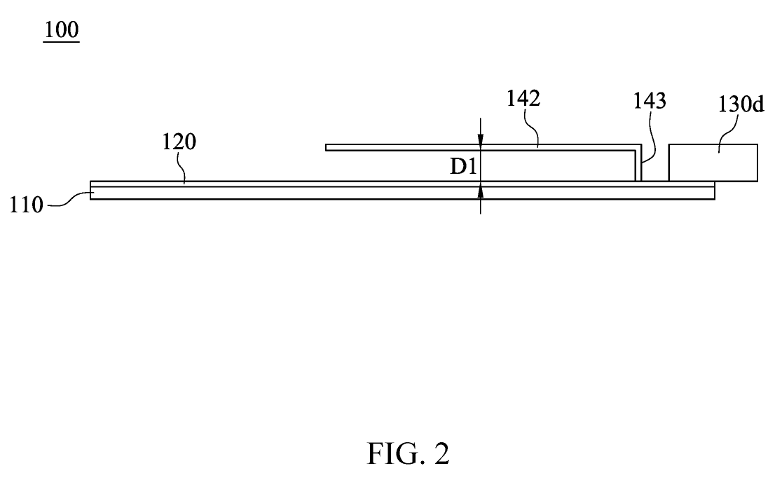

Referring to FIGS. 1 and 2, FIG. 1 is a schematic diagram illustrating an antenna device 100 according to a first embodiment of the present disclosure, and FIG. 2 is a side view schematic diagram of the antenna device 100 of FIG. 1. The antenna device 100 includes a substrate 110, a ground layer 120, connectors 130a, 130b, 130c, and 130d, a metal structure 140, and antenna units (not shown). The ground layer 120 is disposed on the substrate 110. The connectors 130a, 130b, 130c, and 130d are electrically connected to the ground layer 120. The metal structure 140 is connected to the ground layer 120, and two ends of the metal structure 140 are electrically connected to the connectors 130a, 130b, 130c, and 130d, respectively, via the ground layer 120. The antenna units are connected to the connectors 130a, 130b, 130c, and 130d, respectively.

In detail, the substrate 110 may be a PCBA circuit board or another circuit board material. The connectors 130a, 130b, 130c, and 130d may be SMA connectors or other connectors for connecting external antenna units. The antenna units may be external antennas of any type, shape, or function. The metal structure 140 may be an n-shaped structure, a U-shaped structure, or other shapes, but the present disclosure is not limited thereto. The antenna units are electrically connected to components on the substrate 110 through at least one of the connectors 130a, 130b, 130c, and 130d.

In the first embodiment, the metal structure 140 may include a first segment 141, a second segment 142, and a third segment 143. The first segment 141 is disposed on the substrate 110 along a direction perpendicular to the substrate 110. The second segment 142 is connected to the first segment 141 and is perpendicular to the first segment 141. The third segment 143 is connected to the second segment 142 and is disposed on the substrate 110 along the direction perpendicular to the substrate 110. In detail, the first segment 141 and the third segment 143 of the metal structure 140 are connected to the ground layer 120 and stand upright on the substrate 110, while the second segment 142 is connected between the first segment 141 and the third segment 143. Further, the second segment 142 may be parallel to the substrate 110, and a spacing D1 is formed between the second segment 142 and the substrate 110, where the spacing D1 is greater than or equal to 3 millimeters. Thus, the antenna device 100 of the present disclosure can, by connecting the metal structure 140 between two adjacent connectors (i.e., connectors 130a and 130b, and connectors 130c and 130d), greatly shorten the spacing between the connectors 130a, 130b, 130c, and 130d of the full-band external antennas on the substrate 110, while maintaining the radiation characteristics of the external antennas.

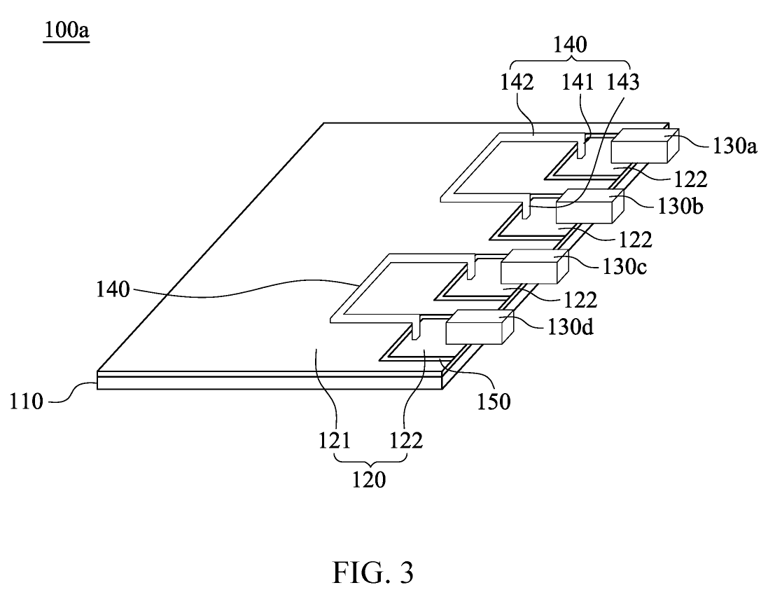

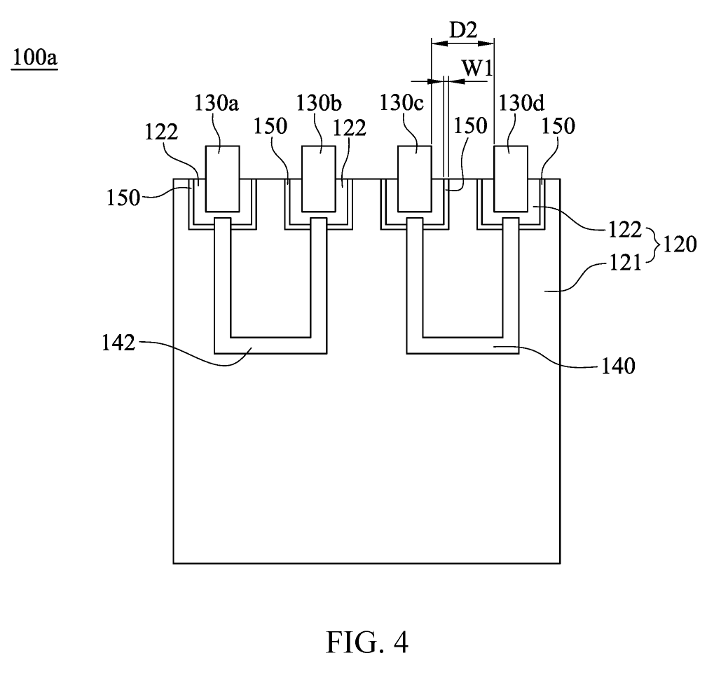

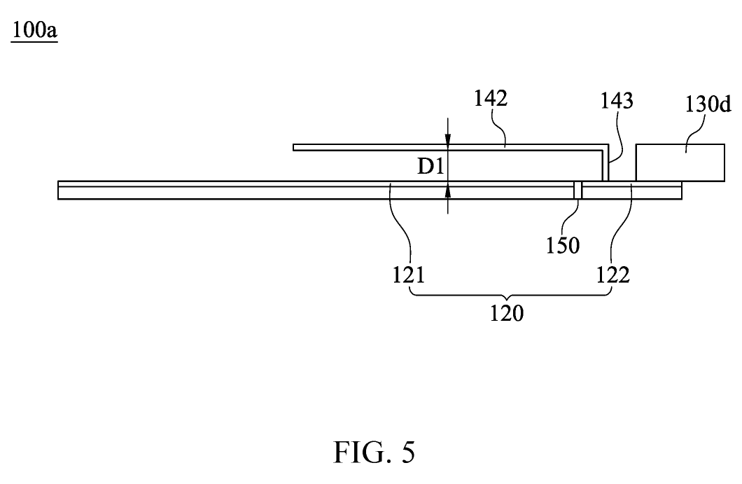

Please refer to FIGS. 3 to 5. FIG. 3 is a schematic diagram illustrating an antenna device 100a according to a second embodiment of the present disclosure; FIG. 4 is a top view schematic diagram of the antenna device 100a of FIG. 3; and FIG. 5 is a side view schematic diagram of the antenna device 100a of FIG. 3. The antenna device 100a includes a substrate 110, a ground layer 120, connectors 130a, 130b, 130c, and 130d, a metal structure 140, and antenna units (not shown). The ground layer 120 is disposed on the substrate 110. The connectors 130a, 130b, 130c, and 130d are electrically connected to the ground layer 120. The metal structure 140 is connected to the ground layer 120, and two ends of the metal structure 140 are electrically connected to the connectors 130a, 130b, 130c, and 130d, respectively, via the ground layer 120. The antenna units are connected to the connectors 130a, 130b, 130c, and 130d, respectively.

The antenna device 100a may further include grooves 150. The grooves 150 are disposed on the substrate 110 and respectively surround the connectors 130a, 130b, 130c, and 130d. The grooves 150 divide the ground layer 120 into a first ground portion 121 and second ground portions 122. The first ground portion 121 is located between the two grooves 150, and the second ground portions 122 are located between the connectors 130a, 130b, 130c, 130d and the grooves 150. The grooves 150 are n-shaped structures or U-shaped structures. Two ends of each groove 150 are located at the edge of the substrate 110, and disposed on both sides of one of the connectors 130a, 130b, 130c, 130d. The two ends of the metal structure 140 are respectively connected to the two second ground portions 122.

In detail, the grooves 150 may be formed by etching the substrate 110 after the ground layer 120 is laid on the substrate 110, or by removing part of the ground layer 120 through other methods, so that the first ground portion 121 and the second ground portions 122 are not electrically conducted. Each second ground portion 122 is electrically connected to the connectors 130a, 130b, 130c, and 130d. Thus, the antenna device 100a of the present disclosure separates the ground layer 120 through the grooves 150, so that the low-frequency characteristics of the antenna units are not affected by adjacent antenna units, and the overall size of the antenna device 100a is reduced.

The spacing D2 between two adjacent connectors (for example, connectors 130a and 130b) is less than or equal to 40 millimeters. In the second embodiment, the substrate 110 has a length of 110 millimeters and a width of 110 millimeters, and the spacing D2 between two adjacent connectors (for example, connectors 130a and 130b) may be 30 millimeters. The width W1 of each groove 150 is greater than or equal to 1 millimeter.

In the second embodiment, the first resonant frequency band of the antenna units is between 617 megahertz (MHz) and 960 MHz, and the second resonant frequency band of the antenna units is between 1450 MHz and 5925 MHz. However, the present disclosure is not limited thereto. The total length of the metal structure 140 is L1, and the wavelength of the lowest frequency of the antenna units is λ, which satisfies the following formula: 1/4 λ ≤ L1 ≤ 1/2 λ. In other words, the total length of the metal structure 140 is the sum of the length of the first segment 141, the length of the second segment 142, and the length of the third segment 143.

In other embodiments of the present disclosure, the total length of the metal structure 140 is L1, and the spacing between the center of one antenna unit and the center of another antenna unit is L2. The wavelength of the lowest frequency of the two antenna units is λ, which satisfies the following formula: 1/4 λ ≤ L1 + L2 ≤ 1/2 λ. Accordingly, the total length and shape of the metal structure 140 vary with the spacing D2 between the connectors 130a, 130b, 130c, and 130d. When the spacing D2 between the connectors 130a, 130b, 130c, and 130d increases, the total length of the metal structure 140 decreases correspondingly.

Furthermore, the antenna device 100a may further include a metal housing (not shown). The metal housing accommodates the substrate 110, the ground layer 120, the connectors 130a, 130b, 130c, and 130d, and the metal structure 140 therein. An another spacing is formed between the metal structure 140 and the metal housing along the direction perpendicular to the substrate 110, and the another spacing is greater than or equal to 3 millimeters. In other words, the metal housing may include a cover, and the spacing between the cover and the second segment 142 of the metal structure 140 is greater than or equal to 3 millimeters, so as to prevent the metal housing from interfering with the radiation characteristics of the antenna units.

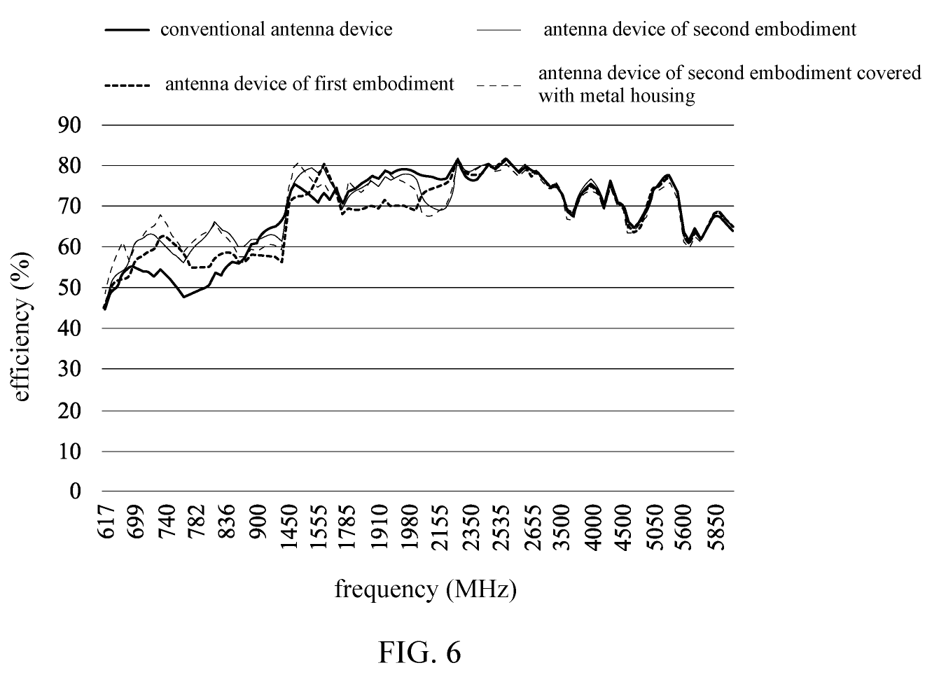

Please refer to FIGS. 1, 3, and 6. FIG. 6 is a schematic diagram illustrating the efficiency of the antenna device 100a of FIG. 3. FIG. 6 shows the efficiency at various frequencies of a conventional antenna device without the metal structure and grooves, the antenna device 100 of the first embodiment, the antenna device 100a of the second embodiment, and the antenna device 100a of the second embodiment covered with a metal housing. As can be seen from FIG. 6, after the metal structure 140, grooves 150, and metal housing are added, the efficiency in the low-frequency range (617 MHz to 1450 MHz) can be significantly improved.

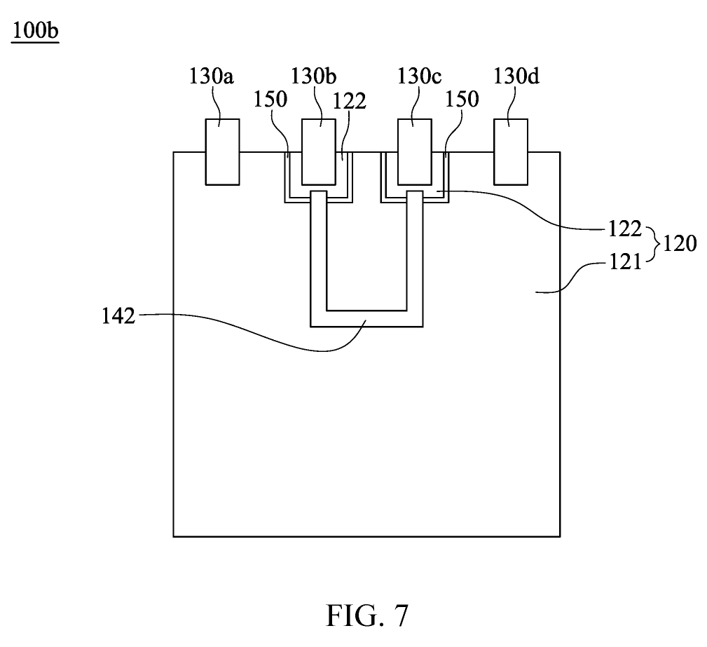

Please refer to FIGS. 3 and 7. FIG. 7 is a schematic diagram illustrating an antenna device 100b according to a third embodiment of the present disclosure. The antenna device 100b includes a substrate 110, a ground layer 120, connectors 130a, 130b, 130c, and 130d, a metal structure 140, antenna units (not shown), and two grooves 150. The ground layer 120 is disposed on the substrate 110. The connectors 130a, 130b, 130c, and 130d are electrically connected to the ground layer 120. The metal structure 140 is connected to the ground layer 120, and two ends of the metal structure 140 are electrically connected to the connectors 130b and 130c via the ground layer 120. The antenna units are connected to the connectors 130a, 130b, 130c, and 130d, respectively. The grooves 150 are disposed on the substrate 110 and respectively surround the connectors 130b and 130c. The grooves 150 divide the ground layer 120 into a first ground portion 121 and two second ground portions 122. The first ground portion 121 is located between the two grooves 150, one of the second ground portions 122 is located between the connector 130b and one of the grooves 150, and the other of the second ground portions 122 is located between the connector 130c and the other groove 150.

In detail, when the area of the ground layer 120 is relatively large and the spacing between the connectors 130a and 130d is greater than 90 millimeters, it is only necessary to provide the grooves 150 and the metal structure 140 between the relatively adjacent connectors 130b and 130c. Thus, the antenna device 100b of the present disclosure can simultaneously maintain the radiation characteristics of adjacent antennas and reduce the overall layout space limitation caused by the metal structure 140.

From the above embodiments, it can be understood that the antenna device of the present disclosure has the following advantages: (1) by connecting the metal structure between two adjacent connectors, the spacing of the connectors of full-band external antennas on the substrate can be greatly shortened, while maintaining the radiation characteristics of the external antennas; (2) by dividing the ground layer with grooves, the antenna units are not affected by the low-frequency characteristics of adjacent antenna units, and the overall size of the antenna device is reduced; and (3) it can simultaneously maintain the radiation characteristics of adjacent antennas and reduce the overall layout space limitation caused by the metal structure.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An antenna device, comprising:
a substrate;
a ground layer disposed on the substrate;
two connectors electrically connected to the ground layer;
a metal structure connected to the ground layer, wherein two ends of the metal structure are electrically connected to the two connectors, respectively, via the ground layer; and
two antenna units connected to the two connectors, respectively.

2. The antenna device according to claim 1, wherein the metal structure is an n-shaped structure or a U-shaped structure.

3. The antenna device according to claim 1, wherein the metal structure comprises:
a first segment disposed on the substrate along a direction perpendicular to the substrate;
a second segment connected to the first segment and perpendicular to the first segment; and
a third segment connected to the second segment and disposed on the substrate along the direction perpendicular to the substrate.

4. The antenna device according to claim 3, wherein the second segment is parallel to the substrate, a spacing is formed between the second segment and the substrate, and the spacing is greater than or equal to 3 millimeters.

5. The antenna device according to claim 4, further comprising:
a metal housing, in which the substrate, the ground layer, the two connectors, and the metal structure are disposed;
wherein an another spacing is formed between the metal structure and the metal housing along the direction perpendicular to the substrate, and the another spacing is greater than or equal to 3 millimeters.

6. The antenna device according to claim 1, wherein a total length of the metal structure is L1, and a wavelength of a lowest frequency of the two antenna units is λ, which satisfies the following formula:
1/4 λ ≤ L1 ≤ 1/2 λ.

7. The antenna device according to claim 1, wherein a total length of the metal structure is L1, a spacing between a center of one of the two antenna units and a center of another of the two antenna units is L2, and a wavelength of a lowest frequency of the two antenna units is λ, which satisfies the following formula:
1/4 λ ≤ L1 + L2 ≤ 1/2 λ.

8. The antenna device according to claim 1, further comprising:
two grooves disposed on the substrate and respectively surrounding the two connectors;
wherein the two grooves divide the ground layer into a first ground portion and two second ground portions, the first ground portion is located between the two grooves, and one of the two second ground portions is located between one of the two connectors and one of the two grooves.

9. The antenna device according to claim 8, wherein the two grooves are n-shaped structures or U-shaped structures.

10. The antenna device according to claim 9, wherein two ends of each of the two grooves are located at edges of the substrate, and disposed on two sides of a corresponding one of the two connectors.

11. The antenna device according to claim 8, wherein the two ends of the metal structure are respectively connected to the two second ground portions.

12. The antenna device according to claim 8, wherein a width of each of the two grooves is greater than or equal to 1 millimeter.

13. The antenna device according to claim 12, wherein a first resonant frequency band of the two antenna units is between 617 MHz and 960 MHz, and a second resonant frequency band of the two antenna units is between 1450 MHz and 5925 MHz.

14. The antenna device according to claim 1, wherein a spacing between the two connectors is less than or equal to 40 millimeters.
